(19) United States
(12) Patent Application Publication
(10) Pub. No.: US 2026/0195825 A1
(43) Pub. Date: Jul. 9, 2026

(54) COMPUTER-IMPLEMENTED ENTITIES AND METHODS FOR ORGANIZING AND ANALYZING ELECTRONIC DOCUMENTS

(71) Applicant: Edmond K. Chow, Hong Kong (HK)

(72) Inventor: Edmond K. Chow, Hong Kong (HK)

(21) Appl. No.: 19/011,580

(22) Filed: Jan. 6, 2025

(51) Int. Cl. G06Q 40/12; G06F 16/16

(52) U.S. Cl. CPC G06Q 40/12; G06F 16/164

(57) ABSTRACT

Disclosed are computer-implemented entities, systems, and methods for organizing, extracting, and/or analyzing data related to electronic documents such as invoices or receipts. These documents comprise content and metadata, with metadata structured to include date, provider, amount, and other relevant information. For instance, metadata may be stored in filenames or as attributes, utilizing fields, delimiters or separators to facilitate parsing. In some embodiments, these entities, systems, and methods enable efficient extraction and organization of data into tabular or structured formats, while supporting advanced analysis such as summarization and calculations. These innovations enhance the handling, retrieval, and management of data pertaining to electronic documents, improving efficiency in record-keeping and file management tasks.

### TECHNICAL FIELD

The present invention relates to computer-implemented entities, systems, and methods for organizing, extracting, and/or analyzing data related to electronic documents such as invoices or receipts.

### BACKGROUND

Digital and electronic receipts and invoices are increasingly prevalent across various contexts, including online shopping, in-person retail, and service transactions, where they are often delivered via email. In personal finance and accounting, users frequently need to extract critical information, such as dates, provider names, and amounts, from these documents manually. Existing technologies, such as Optical Character Recognition (OCR), can assist with this task but often introduce challenges, including operational complexity, increased costs, and potential inaccuracies. Moreover, for tax filings and long-term record-keeping, individuals and businesses must retain receipts and invoices, whether originally paper-based and later digitized or natively electronic. Regardless of their origin, these documents often require identification and extraction of amount information for use in expense reports or tax calculations. Current methods for managing and processing these documents lack efficiency and scalability, underscoring the need for a streamlined approach to generate, organize, and analyze electronically stored receipts and invoices effectively.

### SUMMARY

According to one embodiment, a computer-readable entity is provided or configured to include both content and metadata, wherein the metadata comprises purpose-specific core data, allowing the entity to be processed efficiently for a given purpose without the need to access the content. In one embodiment, the metadata may be stored in a filename or file path, employing delimiters or separators to distinguish between different types of information, where the filename or file path identifies a computer-readable entity, such as a computer file or an electronic document in a filesystem or cloud storage. In another embodiment, the metadata may be stored as extended file attributes associated with a file or document. The purpose-specific core data are directly associated or coupled with the content, enabling the computer-readable entity to be efficiently categorized, retrieved, or processed without the need to access or process the content itself. For example, an electronic receipt may have a filename comprising date, provider, and amount information, formatted to facilitate seamless parsing and analysis, without relying on complex data recognition technologies like Optical Character Recognition (OCR).

The present invention also includes systems and methods configured to extract, organize, and analyze large quantities of electronic documents via their core data sets with minimal resources and little human intervention. For instance, a method may involve reading the metadata of multiple electronic documents, retrieving purpose-specific core data from the metadata, such as filenames or extended attributes, and organizing the core data and other data into a tabular format. In one embodiment, the electronic documents may also be grouped by provider or date in categorized directories, streamlining workflows, retrieval, and audit processes. For example, a directory may be automatically created for each provider, with corresponding documents stored within based on extracted metadata. In one embodiment, hyperlinks to electronic documents may be generated or added to a spreadsheet or database to associate the individual documents with their respective entries, rows, or records of core and other data in the spreadsheet or database.

Furthermore, the present invention may be configured to support downstream processes, such as financial calculations, summarization, and tax preparation, by leveraging structured metadata. In one embodiment, the metadata from multiple documents may be aggregated into a database or spreadsheet, and calculations may be performed based on fields such as amounts and providers. For example, an embodiment of the present invention may determine totals from aggregated metadata or identify matching documents based on shared attributes. Additionally, the structured metadata ensures data integrity and long-term usability by maintaining consistent formatting and accessibility across different systems and platforms. Embodiments of the present invention enhance scalability and efficiency, particularly in handling large volumes of electronic documents for both personal and professional applications.

Moreover, the present invention may be configured to support upstream processes, such as retrieving electronic receipts or invoices from a cloud service or receiving them via email. In one embodiment, a method or system may identify electronic receipts or invoices that lack proper metadata and assist in creating it. For example, the method or system may make an API call to a Large Language Model (LLM) with the electronic receipt or invoice as input and request it to determine the values of the core and other data. The method or system may then generate the metadata, associate it with the receipt or invoice, and mark the resulting file as generated or modified, allowing a user to verify the metadata manually if desired.

### OBJECTS AND ADVANTAGES

The present invention provides a significant improvement in managing electronic documents, such as invoices and receipts, by making purpose-specific core data readily accessible and available on the electronic documents themselves. For instance, purpose-specific core data may refer to the essential information, such as date, provider, and amount, necessary for completing financial and record-keeping tasks. For example, an embodiment of the present invention enables date, provider, and amount information to be directly accessible via the filename of an electronic receipt, facilitating seamless organization and retrieval. By embedding such core data into filenames or extended file attributes and employing delimiter-based formatting, this embodiment eliminates the need for complex data recognition technologies like OCR, offering a more reliable and efficient means of accessing and processing information.

Through its ability to automate the categorization and retrieval of documents, an embodiment of the present invention addresses common inefficiencies in record-keeping and financial workflows. Metadata parsing enables the rapid organization of electronic documents into categorized directories, such as those grouped by provider or date. Extracted metadata can also be structured into tabular formats, supporting downstream processes such as financial analysis, expense reporting, and tax preparation. The automated and scalable design of embodiments of the present invention makes them particularly valuable for handling large volumes of documents, ensuring consistency and accuracy across multiple formats and systems.

By supporting advanced analytical capabilities and ensuring data integrity, embodiments of the present invention enhance the utility of electronic documents in various applications. Structured metadata ensures that essential information remains intact and accessible for long-term record-keeping and facilitates interoperability across platforms. This adaptability, combined with the ability to streamline workflows and reduce manual effort, establishes embodiments of the present invention as essential tools for improving the efficiency and effectiveness of financial and organizational tasks in both personal and professional settings.

Further objects and advantages will become apparent from the present disclosure, including the drawings, to those skilled in the art.

### BRIEF DESCRIPTION OF THE DRAWINGS

FIG. 1 illustrates one or more computer-readable entities in accordance with an embodiment of the present invention.

FIG. 2 illustrates one or more computer-readable entities in accordance with another embodiment of the present invention.

FIG. 3 illustrates an exemplary computing environment for a process or system in accordance with an embodiment of the present invention.

FIG. 4 illustrates a flow diagram of an exemplary process in accordance with an embodiment of the present invention.

FIG. 5 illustrates a flow diagram of another exemplary process in accordance with an embodiment of the present invention.

FIG. 6 illustrates a flow diagram of an exemplary process in accordance with another embodiment of the present invention.

FIG. 7 illustrates a flow diagram of another exemplary process in accordance with another embodiment of the present invention.

### DETAILED DESCRIPTION OF ILLUSTRATIVE EMBODIMENTS

The present invention relates generally to computer-readable entities, systems and methods for embedding and utilizing metadata in or alongside electronic documents, such as receipts or invoices, to facilitate efficient extraction, organization, storage, and analysis of critical information. For instance, embodiments of the present invention may provide computer-readable entities, such as files, that include both content (e.g., the body of a receipt or invoice) and purpose-specific core data (e.g., date, provider, and amount) stored as metadata in filenames, file paths, or extended file attributes. This arrangement allows downstream processes, such as expense reporting and tax calculation, to be conducted more efficiently with minimal human intervention. As used herein, ‘metadata’ refers to information stored in association with a document, such as that embedded in filenames or extended attributes. ‘Core data’ refers to data relevant to a specific purpose such as date, provider, and amount for financial or managerial accounting.

In one embodiment, an electronic document (e.g., a PDF, image file, or text document) comprises two primary components: (1) content, such as the original receipt or invoice text and images, and (2) metadata, which includes purpose-specific core data such as date information, provider information, and amount information. When the metadata is stored in the filename or the path of the electronic document, various parsing routines can quickly retrieve and process these core data fields without needing to open or analyze the content itself. Such metadata may be placed in specific positions within a filename, separated by delimiters or other predefined markers. Such filenames enable users to take advantage of the purpose-specific core data via commonly available computing environments or tools, such as a native filesystem or a spreadsheet application.

In another embodiment, the metadata may be stored using extended file attributes rather than within the filename. Here, operating systems or storage environments that support extended attributes allow the attachment of structured data fields, such as a “date” attribute, a “provider” attribute, and an “amount” attribute, directly to the file. This approach enables software applications or scripts to parse, index, and sort large numbers of documents by merely reading the extended attributes. For example, a system or process may store each piece of metadata as a dedicated attribute. For example, “user.date=2024-01-01,” “user.provider=Amazon,” and “user.amount=59.99.” Tools to read or write these attributes could be native OS utilities (e.g., “xattr” on macOS/Linux) or custom scripts. Security measures, such as restricting attribute editing rights, can be adopted to preserve data integrity.

In yet another embodiment, the entire workflow may rely solely on the filename for metadata storage, for example, based on a given filesystem or user-imposed operational constraints. The system can parse date, provider, and amount from the filename, ignoring extended attributes. Alternatively, the system might perform a fallback approach, using the filename if extended attributes are unavailable or unsupported, or vice versa.

In one embodiment, a system or process may comprise retrieving or receiving electronic receipts or invoices from various sources (e.g., email, cloud services, downloads). If the core data (e.g., date, provider, amount) is not included or otherwise associated with a receipt or invoice, the requisite metadata may be automatically or semi-automatically extracted or generated from the content. For instance, a user or an automated tool may detect or infer the date, provider, and amount from the content of the receipt or invoice and then record this information in the filename or extended attributes. In certain implementations, a Large Language Model (LLM) or another AI-based service can be employed to identify the relevant fields (e.g., date, provider, amount) from the document content and recommend or directly insert them into the metadata, reducing as much manual effort as desirable. In one embodiment, upon detecting that metadata is incomplete or conflicts with existing records, a system or process may invoke a user verification step or apply predefined rules to resolve discrepancies (e.g., prioritizing metadata embedded in extended attributes over filenames).

Once metadata is stored as filename or otherwise associated with each electronic document, a categorization or organizing step can take place. For example, in one embodiment, a computer system or process can evaluate each document's metadata to decide which folder or directory to place it in. Documents belonging to a particular provider may be grouped in a directory named after the provider, while documents with a specific date range or year can be grouped into yearly or monthly directories. Such structured organization enables quick retrieval, especially during financial audits or tax preparation.

For instance, in embodiments that store metadata within a filename for accounting applications, the core data (e.g., the date, provider, and amount) fields may be sequentially placed and separated by delimiters (e.g., underscores, dashes, or other characters). An exemplary filename could be: 2024-01-01_Amazon_59.99_Laptop Case.pdf, where the date information is “2024-01-01”, provider is “Amazon”, amount is “59.99”, and description “Laptop Case”, with the single underscores as the delimiter. Parsing scripts or applications can scan the filename from left to right, using “_” to segment these fields. In one embodiment, should a character in the provider or description information be a delimiter, it can be escaped with repeating the character once for each occurrence, so that it can be distinguished from its delimiting counterpart. For example, if a single underscore “_” is used as a delimiter, then each underscore in the provider or description information will be replaced with a double underscore “__”. Many possible delimiters can be used, including underscores (_), double underscores (__), hyphens (-), double hyphens (-), or even bracket-based formats. A user, system or process may recognize multiple possible separators in parallel, thereby supporting legacy file naming conventions. For instance, “2024-01-01_Amazon_59.99.pdf” and “2024-01-01-Amazon-59.99.pdf” may both be valid. One of ordinary skill in the art would appreciate any suitable format or delimiter that meaningfully separates the fields.

In some operating systems, a file can contain custom attributes. These attributes, often referred to as “key-value” pairs, may include: date_attribute=“2024-01-01”, provider_attribute=“Amazon”, and amount_attribute=“59.99”. Software tools that read extended attributes can directly parse these values without opening the file content. This arrangement is especially helpful when filenames need to remain user-friendly or comply with existing naming conventions.

In one embodiment, a computer system or process may iterate through a directory structure, scanning each file to retrieve core data fields. If filename-based metadata is used, the process splits the filename at each delimiter, extracting date, provider, and amount. If extended attributes are used, the process reads these values from each file's attribute store. In another embodiment, after the core data fields have been extracted, they can be added to an internal or external database, spreadsheet, or other data repository. Each record in the data repository corresponds to one electronic document, storing at least the date, provider, and amount fields, and optionally storing additional data such as file location, currency type, item description, and payment frequency. By aggregating metadata from multiple documents, the system can easily perform summations (e.g., total amount per provider), grouping or filtering based on date ranges (e.g., monthly or yearly totals), and comparisons for auditing or identifying duplicate receipts. In some embodiments, a computer system or process may create hyperlinks or file references in the spreadsheet or database. Clicking a link opens the corresponding receipt or invoice for rapid verification.

In one embodiment, a computer system or process may sort or relocate files into directories based on their metadata. For example, upon detecting “Amazon” in the provider field, the system may create or locate a directory labeled “Amazon,” placing the file there. This approach yields a hierarchical directory structure aligned with metadata fields, significantly easing manual browsing and retrieval.

In one embodiment, if a receipt or invoice arrives without metadata or with incomplete metadata, a system or process may invoke an external API or service, such as an LLM, to parse the content. For instance, the LLM is queried with the full text (or partial snippet) of the receipt, and it returns probable values for the date, provider, and amount. For example, the LLM may be accessed via a REST API, which transmits receipt documents securely using encrypted protocols. Responses include structured metadata, which is parsed and verified by the system or process before integration or further processing. The system or process may then embed these values into the filename or extended attributes. A user may verify and confirm these automatically extracted values, ensuring data integrity.

In another embodiment, a computer system or process may identify and acquire electronic receipts or invoices. For instance, it may automatically monitor certain email inboxes or cloud storage locations. Whenever new documents are detected, the system or process triggers the metadata extraction routines to maintain an up-to-date and organized record-keeping environment. In yet another embodiment, a computer system or process may receive input from a user for the specification of the metadata, such as types, labels, formats and delimiters, to generate and/or parse the metadata of interest. In one embodiment, a user may define the core data set as well as any other data for metadata of interest. For example, a user may include an invoice or receipt number in addition to date, provider and amount as required, and a description as optional. In addition, the metadata may comprise additional categorizing fields, such as whether the invoice or receipt is for business or personal expenses, or if it is for a period subscription or a one-time purchase. Such a categorizing field may also introduce related fields that are applicable only if the value of the categorizing field is of a certain value. For example, if the invoice or receipt is of subscription, then related fields may be the frequency (e.g., monthly or annually) or the period of the subscription.

In one embodiment, the present invention may encompass a cloud-based platform that allows providers to deliver electronic receipts and invoices directly to a user, serving as an alternative to email delivery. A user may configure a cloud-based drop box or repository and authorize specific providers to upload documents into the drop box. For example, a user could grant access to their preferred retailers, service providers, or financial institutions to deposit receipts and invoices into their designated cloud storage account. Upon delivery of each electronic document, the system or process embodying the present invention automatically processes the document. This includes reading and parsing its metadata (e.g., date, provider, amount), extracting relevant information, and updating a spreadsheet or database in real-time with a new entry corresponding to the delivered document. The spreadsheet may include fields for the parsed metadata as well as hyperlinks to the original electronic document in the cloud repository. This approach streamlines the document organization process, eliminating the need for users to manually manage emailed receipts and invoices, while ensuring seamless integration between provider deliveries and user record-keeping systems.

With well-structured metadata in place, embodiments of the present invention may also support advanced downstream use cases. For example, for financial and managerial accounting, these use cases include but not limited to: (1) generating an expense report by summing amounts for specified periods or providers for expense reporting; (2) producing a comprehensive list of receipts with minimal manual data entry for tax preparation; and (3) enabling efficient analysis of time or provider-based spending trends for analytics.

In one embodiment, a computer system or process may read, add, and/or update a status field as part of the metadata, such as whether an invoice has been partially or fully paid. For example, the filename of the invoice may comprise a second amount field (e.g., after the first amount field or the description field). The second amount field can indicate the amount paid (e.g., “Paid 34.00”), and/or if the full payment has been made (e.g., “PAID”). When the file is first received with unknown status, this second amount field may be set to “0.00” or “Unknown”. Once the file has been processed and subsequently managed by the computer system or process, any update to the status of the invoice by the user or via a third-party system (e.g., a new invoice or receipt matching the invoice or receipt number of the first file, or a subsequent analysis by an LLM of the payment status of the invoice) will cause the system or process to update the filename in question.

The embodiments described above illustrate the versatility and scalability of the present invention in embedding and utilizing metadata for the efficient management of electronic documents such as receipts and invoices. The invention supports multiple workflows, including metadata extraction, organization, and downstream processing for applications in accounting, analytics, and tax preparation. By enabling purpose-specific core data to be stored as metadata in filenames, file paths, or extended attributes, and allowing for flexible configurations of core and other data, such as date, provider, amount, and status fields, the invention facilitates seamless integration with existing tools and systems. Furthermore, the ability to automatically or semi-automatically generate, parse, and update metadata using methods such as delimiter-based parsing, LLM-assisted extraction, and real-time status updates demonstrates the adaptability of the invention to dynamic and high-volume environments. These capabilities are further enhanced by user-configurable parameters, enabling personalization and alignment with specific organizational needs.

The present invention is not limited to the examples provided. It encompasses a wide range of variations, including advanced metadata-driven features such as automatic folder creation, dynamic record updates, and multi-tiered categorization. For instance, hierarchical directory structures can be generated based on user-defined metadata fields, while downstream processes such as expense reporting and trend analysis can be conducted directly from metadata-organized repositories. Additionally, the invention accommodates upstream processes, such as acquiring documents from diverse sources (e.g., cloud services, email), ensuring a holistic approach to document lifecycle management.

The following sections, supported by illustrative figures, further detail the computer-readable entities, systems and methods of the invention. These include representations of computer-readable entities, examples of metadata structures, workflows for metadata generation and updating, and applications of the invention in example use cases. They also illustrate the structural relationship between the content and metadata of an electronic document and highlight the various formats and configurations made possible by the invention. Moreover, they expand on the organization, processing, and integration capabilities of the invention, demonstrating its practical implementation across a variety of scenarios.

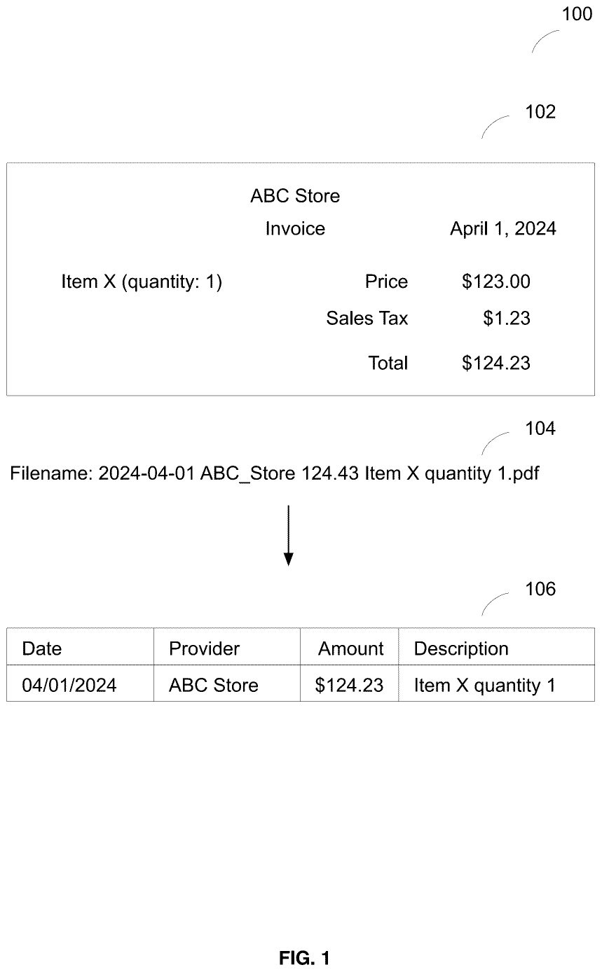

FIG. 1 illustrates one or more computer-readable entities 100 in accordance with an embodiment of the present invention. An electronic document 102 comprises date information (“Apr. 1, 2024”), provider information (“ABC Store”), and amount information (“$123.00”), as well as other information (e.g., “Item X” and “quantity: 1”) that pertain to a sales receipt or invoice. The electronic document 102 is associated with a filename 104, in which the date, provider, and amount fields may be considered as required, while any information that follows the amount field is considered optional, which in this case comprises the item and quantity information. This optional field may be referred to as a description field. Spaces are used as delimiters between the date and provider fields and between the provider and amount fields. Spaces in the original or source value of the provider field are replaced with underscores. The description field comprises what, if any, follows the amount field after spaces, thereby allowing spaces in the data in the description field. The values of these fields and the filename can be generated by the originator of the electronic document, through a manual process by a user, through automation such as machine learning, or a combination thereof.

For instance, an attachment in an email may comprise an electronic receipt or invoice whose filename comprises date information. The electronic receipt is then uploaded to an LLM that is instructed to confirm the date and extract provider, amount and description information to create a new filename in accordance with a format specification. A user then will verify the resulting filename and either confirm or request to correct it. The LLM will then return a new electronic document whose content is the same as the uploaded one, but with the new filename. With this electronic document comprising the content of a receipt or invoice and the metadata (i.e., date, provider, amount and description information) in form of a filename, a computer system or process may then parse the filename, extract the constituent data fields, and create an electronic entry or record 106 suitable for storage and manipulation via a data store, such as a spreadsheet or a database.

In one embodiment, an electronic document may be in any suitable format, such as PDF, DOCX, TXT, JPEG, or PNG, and it includes both the content and metadata with at least date, provider, and amount information. Variations include storing the metadata as extended attributes to the file of the content or embedding it directly in a filename or file path. In some embodiments, the content may include images of a receipt or a textual invoice, while the metadata is used primarily for quick indexing and retrieval. Numerous delimiter styles may be used (e.g., underscores, hyphens, plus signs, spaces), and the order of fields (date-provider- amount) may vary. Additionally, the filename could include extra indicators for file status or version control (e.g., “WIP” or “Final”).

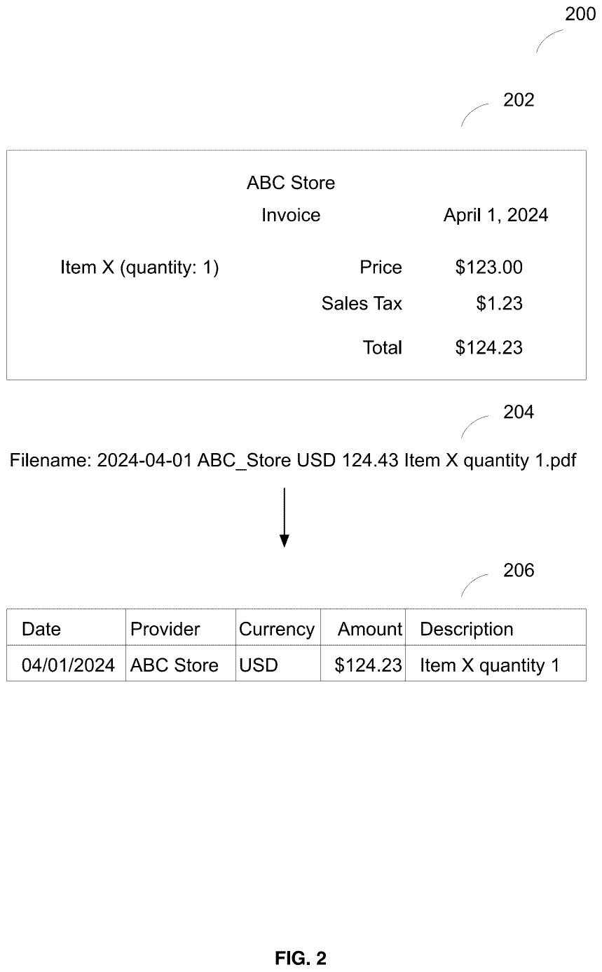

FIG. 2 illustrates one or more computer-readable entities 200 in accordance with another embodiment of the present invention. An electronic document 202 comprises the same receipt or invoice information as the electronic document 102 in FIG. 1. A filename 204 that comprises currency information is associated with the electronic document 202, where no currency information is shown. In one embodiment, the currency information may be specified as a system default or user input prior to the origination or creation of the electronic document 202 or the filename 204, or as a result of automatic processing and/or user input after such origination or creation. The corresponding currency field in the filename may also be optional, where a computer system or process may parse a filename to look for a currency label (e.g., USD) and/or a numerical value (e.g., a decimal number) after the provider field. Absence of a currency label and/or presence of a numerical value may indicate that currency is not applicable for the amount, or the currency of interest is the default one as deemed by the user, system or process. Consequently, the system or process may parse the filename, extract the constituent data fields, and create an electronic entry or record 206 suitable for storage and manipulation via a data store, such as a spreadsheet or a database.

In one embodiment, currency information can be appended to or integrated within the amount field, such as “$59.99” or “USD-59.99.” A variety of currencies and symbols may be supported. Alternatively, the currency indicator may precede or follow the numeric value, depending on the region or user preference, or what the underlying filesystem or cloud storage may support. The decimal format for amounts may similarly vary (e.g., decimal points, commas for European notation, or integer values in smaller currency units). In addition, the date could be in ISO format (YYYY-MM-DD), MM-DD-YYYY, or any format recognized by the system, and the provider information may include business names with spaces (e.g., “Best Buy” or “John's Bakery”) or symbols (e.g., apostrophes, hyphens), subject to the chosen mechanism of delimitations and escaping, as well as any naming limitations in the underlying file system. For instance, the filename may contain multiple distinct separators for clarity. For example, “2024-01-01__Amazon__59.99” might use double underscores, while another implementation might use parentheses or brackets to isolate fields, such as “[2024-01-01] [Amazon][59.99].pdf.” The system can be configured to detect one or more of these delimiter schemes dynamically.

In another embodiment, beyond the core fields (e.g., date, provider, amount), the filename can also embed additional data (e.g., an item description, currency type, payment frequency, or project code). For instance, “2024-01-01-Amazon-59.99-LaptopCase- USD.pdf” might be parsed by looking for four or five delimiters. In some embodiments, these additional fields might be optional and only populated in specific use cases.

In one embodiment, where the content includes multiple items or line details, the description field, or the “other information”, in the filename or metadata might include a short label or code referencing the main item purchased. If the file is an invoice covering many items, this field might reflect the total or highlight a primary item. Various methods can be used to link multiple item records from the content to a single metadata field, such as using semicolons or pipe characters (e.g., “Item1|Item2|Item3”).

In another embodiment, instead of placing metadata in a filename, the system may utilize extended file attributes supported by operating systems like macOS, Linux, or Windows (via alternate data streams or similar mechanisms). Date, provider, and amount attributes can be named as “xattr.date,” “xattr.provider,” or “xattr.amount,” among others. Variations include storing additional attributes, such as “xattr.taxCategory” or “xattr.invoiceNumber”.

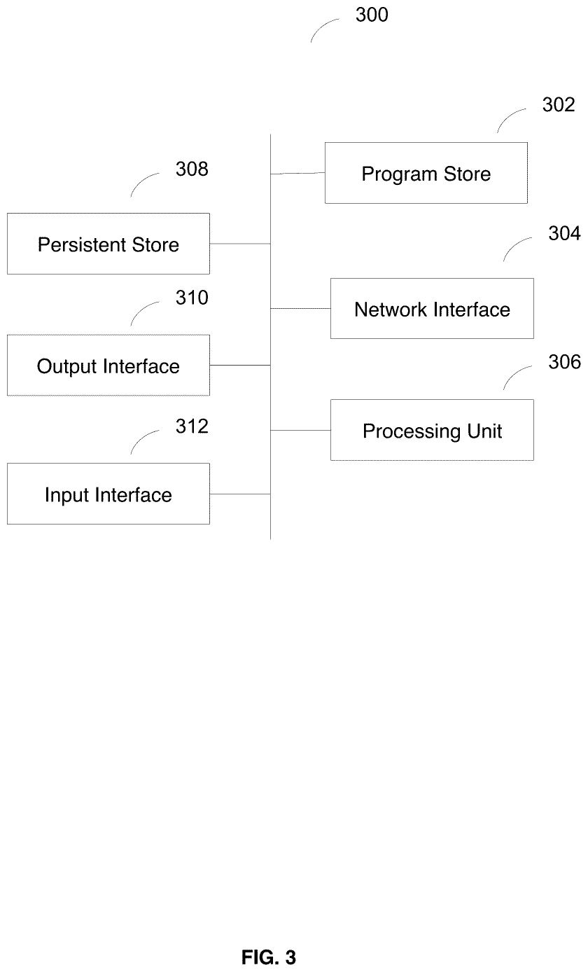

FIG. 3 illustrates an exemplary computing environment for a process or system in accordance with an embodiment of the present invention. It comprises an example block diagram 300 illustrating components of an exemplary computing environment in which a process or system in accordance with an embodiment of the present invention may comprise or utilize. For instance, Program Store 302 contains executable code for parsing and updating metadata. This code is executed by Processing Unit 306, which performs tasks such as extracting metadata, renaming files, and updating records. For remote services such as cloud storage or LLM-based processing tools, Processing Unit 306 coordinates these operations through Network Interface 304.

Persistent Store 308 manages document storage and version control, serving as a repository for computer-readable entities such as those shown in FIGS. 1 and 2. Persistent Store 308 may include a local filesystem, a relational or NoSQL database, or a cloud-based storage system accessed through Network Interface 304. This configuration enables secure and scalable storage for both content and metadata. Network Interface 304 facilitates communication between local and remote components, supporting the transfer of data and ensuring that metadata remains synchronized across distributed systems.

Output Interface 310 enables the presentation of filenames, metadata, and operational artifacts, such as processed receipts or generated hyperlinks, to a user through a computer display or terminal. Input Interface 312 provides mechanisms such as keyboards, trackpads, or APIs for users to interact with the system, allowing them to specify metadata fields, confirm updates, or trigger file organization processes. These interfaces ensure that the system remains user-friendly while supporting advanced workflows. By integrating these components, the computing environment can handle diverse scenarios, from small-scale metadata updates to enterprise-level document processing.

This modular design further supports concurrent and distributed processing scenarios. For example, multiple Processing Units 306 may collaborate to handle high-volume workloads, with Persistent Store 308 synchronized across nodes via Network Interface 304. This design ensures scalability and reliability while allowing seamless integration with third-party systems, including external databases, APIs, or analytics platforms.

It is to be noted that, depending on specific embodiments or applications, one or more components in FIG. 3 may not be needed, or a component may have different functionality as described. For example, if all the relevant processing is confined to a user's local computer, then it may not involve Network Interface 304. Program Store 302 could be split into two separate components, one that is local to the user computer, while the other is a collection of applications accessible via API over a network. Additionally, FIG. 3 is not intended to provide an exhaustive list of components. For example, a printed circuit board (PCB), not shown in FIG. 3, could be considered a component, which provides electrical connections among components and is where they are mounted, if all such components are constituent parts of a computer. Alternatively, a physical or virtualized system implementing an embodiment of the invention may have one or more processors (CPUs, GPUs, or specialized AI accelerators) and memory modules (RAM, disk storage, cloud storage). The system may be distributed across multiple nodes or run locally on a single machine. Variations include server-client architectures, where a back-end server performs metadata extraction, a front-end client application displays or modifies the metadata, or a combination thereof. Additionally, the system may include mobile apps that allow users to capture receipts using smartphone cameras and automatically generate the requisite metadata. One of ordinary skill in the art would readily appreciate the illustrative nature of FIG. 3 and the disclosure pertaining to it.

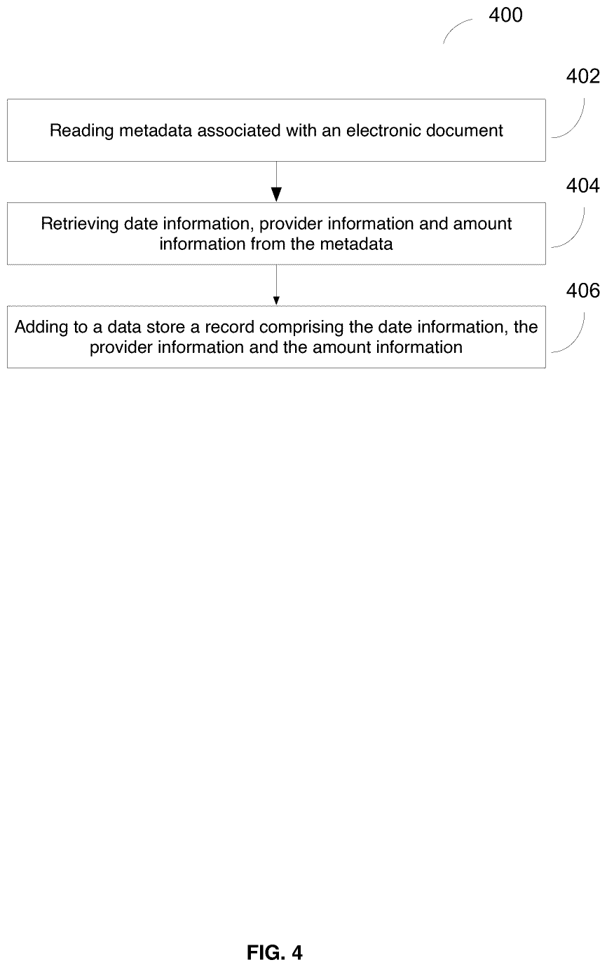

FIG. 4 illustrates a flow diagram of an exemplary process in accordance with an embodiment of the present invention. A computer system or process embodying the present invention or otherwise equipped with the present invention, examples of which are shown in FIG. 1, FIG. 2, and/or FIG. 3, may carry out, implement, or otherwise effect the exemplary process. Per the exemplary process 400, such a system or process may read metadata associated with an electronic document (402). For instance, a system or process may perform a scanning routine that iterates through directories, retrieving each file's metadata. Variations include scanning multiple drives, cloud storage services, or remote servers. The system or process may also apply certain filters (e.g., ignoring files without known delimiters or skipping read-only folders).

Per the exemplary process 400, the system or process may retrieve date information, provider information and amount information from the metadata (404). For instance, a system or process may parse and extract date, provider, and amount from the metadata, such as from filenames or extended attributes for each retrieved file.

Per the exemplary process 400, the system or process may add to a data store a record comprising the date information, the provider information and the amount information (406). For instance, a system or process may add the extracted data (date, provider, amount, and possibly currency or item details) to any suitable data store, such as SQL databases, NoSQL databases, or cloud spreadsheets like Google Sheets or Excel Online. In one embodiment, the system or process may also compute sums or averages or make comparisons to produce one or more summation results (e.g., total expense for a given provider). Variations include generating custom reports, real-time dashboards, or triggering notifications if amounts exceed a threshold.

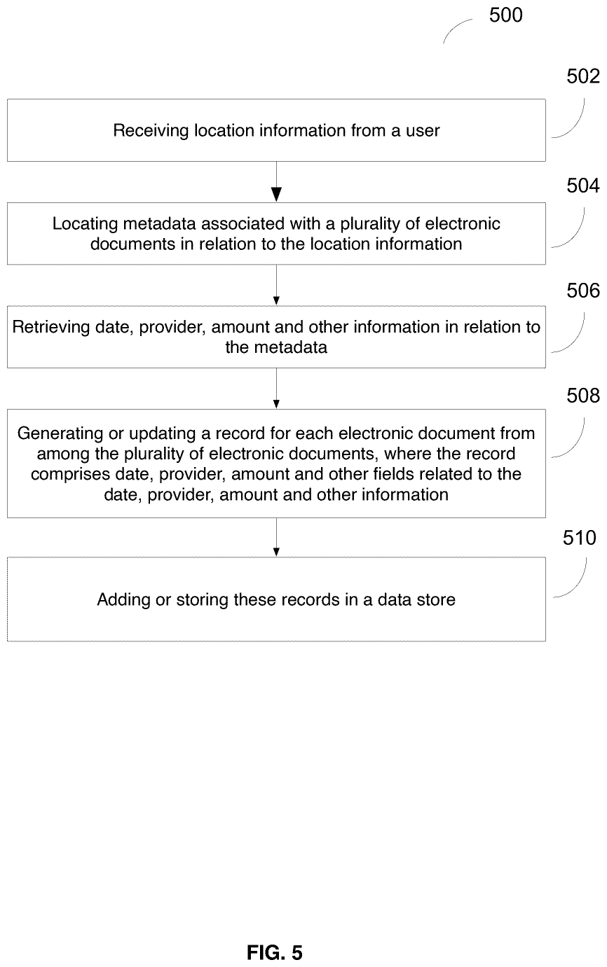

FIG. 5 illustrates a flow diagram of another exemplary process in accordance with an embodiment of the present invention. A computer system or process embodying the present invention or otherwise equipped with the present invention may carry out, implement, or otherwise effect the exemplary process. Per the exemplary process 500, such a system or process may receive location information from a user (502). For instance, a system or process could prompt a user to specify a local path, a network drive, or a cloud storage path as the “location information.” In another variation, the user might provide a URL or an access token for remote services (e.g., Amazon S3 buckets or a SaaS platform). In one embodiment, the resulting data, such as sums or other calculated values, can then be saved back to the same or a different data store or spreadsheet based on the location information.

Per the exemplary process 500, the system or process may locate metadata associated with a plurality of electronic documents in relation to the location information (504). For instance, the location information may refer to a local folder or directory on a user's computer, and a system or process may read the filename of each of the file in the directory.

Per the exemplary process 500, the system or process may retrieve date, provider, amount and other information in relation to the metadata (506). For instance, a system or process may parse and extract date, provider, amount and invoice number from the metadata, such as from filenames or extended attributes for each retrieved file. In one embodiment, the other information may be identified as a “description” field, with the filename structure for the metadata resembling “[DATE]-[PROVIDER]-[AMOUNT]-[DESCRIPTION].pdf”. After extracting the three core data fields, a system or process may capture a “description” field, which may include a short label like “Laptop Case”, a cost center code like “CC123”, or some user note. This extra field can appear in a separate column in the final spreadsheet or database.

Per the exemplary process 500, the system or process may generate or update a record for each electronic document from among the plurality of electronic documents, where the record comprises date, provider, amount and other fields related to the date, provider, amount and other information (508). For instance, a system or process may identify an invoice number among the fields in a filename associated with an electronic document and create a record comprising an invoice record field corresponding to the invoice number, in addition to the date, provider, and amount fields. In one embodiment, the system or process may check for existing records based on some identifying data, such as an invoice number, for update in lieu of new record creation.

Per the exemplary process 500, the system or process may add or store the generated or updated records in a data store (510). For instance, a system or process may add the extracted data (e.g., date, provider, amount, and invoice number) to any suitable data store, such as SQL databases, NoSQL databases, or cloud spreadsheets like Google Sheets or Excel Online. In one embodiment, the system or process may use the user-provided location information to generate or update a spreadsheet comprising the records for these electronic documents. In another embodiment, a system or process may read hundreds or thousands of PDF receipts stored in a particular directory or network drive. It extracts the date, provider, and amount from each file, populating columns in a table, one row per file. Additional columns can hold other individual pieces of information, such as currency codes, item descriptions, or folder paths. In one embodiment, a single electronic document may be associated with multiple records, each being associated with a part of the document. For example, in response to a user request, a LLM may identify three expense items from the same document that the user wishes to be accounted for separately, such as a personal subscription expense, a business one-time purchase, and personal one-time expense. As such, three records may be generated in relation to the same document. In one embodiment, such a document may be duplicated so that there will be three copies, each with a filename comprising fields that correspond to its relevant record, even when the content of each of the three documents is the same.

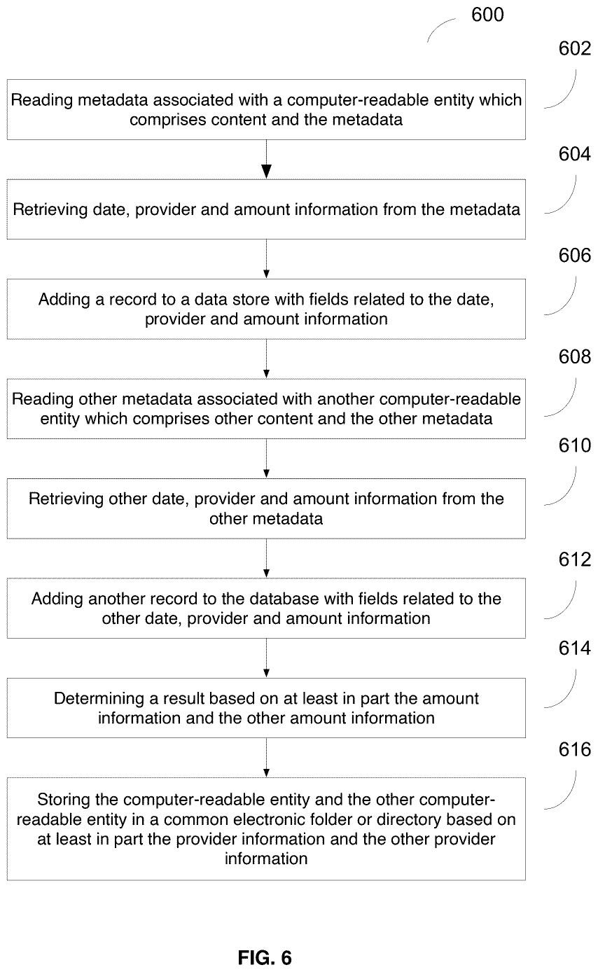

FIG. 6 illustrates a flow diagram of an exemplary process in accordance with another embodiment of the present invention. A computer system or process embodying the present invention or otherwise equipped with the present invention may carry out, implement, or otherwise effect the exemplary process. Per the exemplary process 600, such a system or process may read metadata associated with a computer-readable entity which comprises content and the metadata (602). The system or process may retrieve date, provider and amount information from the metadata (604), and add a record to a data store with fields related to the date, provider and amount information (606). It may process in a similar manner at least one another computer-readable entity (608)-(612). Then the system or process may determine a result based on at least in part the amount information and the other amount information from the at least one other computer-readable entity (614). For instance, it may calculate the sum of the amounts for a given year, or the sum for each provider over a given year.

Per the exemplary process 600, the system or process may store the computer-readable entity and the at least one other computer-readable entity in a common electronic folder or directory based on at least in part the provider information and the other provider information (616). For instance, when the system or process determines that the metadata of two or more computer-readable entities share a provider name, it may group them into a single folder or directory tree (e.g., /Invoices/Amazon/). Different matching rules can be used, such as an exact string match (case-sensitive or case-insensitive) or approximate matching using fuzzy logic (e.g., “Amzn” might match “Amazon”). This process can occur at the time of creation of the metadata or at any subsequent reorganization event. In another embodiment, a system or process may handle hierarchical or nested organization. For instance, subfolders could be created by year (/Invoices/2024) and, inside each year, a subdirectory for each provider (/Invoices/2024/Amazon). Variations include organizing by both date and provider, or by additional criteria (e.g., tagging receipts with “personal” vs. “business” as a field in the metadata).

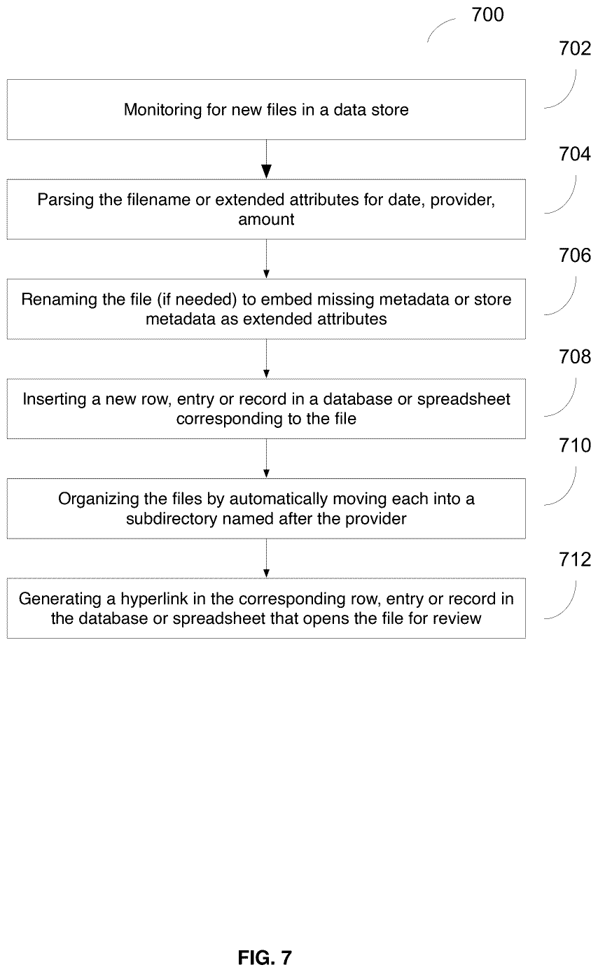

FIG. 7 illustrates a flow diagram of another exemplary process in accordance with another embodiment of the present invention. A system or process embodying the present invention or otherwise equipped with the present invention may carry out, implement, or otherwise effect the exemplary process. Per the exemplary process 700, such a system or process may monitor for new files in a data store (702). For instance, a system or process may periodically check a designated data store, such as a local filesystem directory, network drive, or cloud repository, for newly added or modified files. For example, a background script may execute at predetermined intervals (e.g., every five minutes) to poll the data store's directory listings. Alternatively, a file-system event listener may be employed, triggering a callback function whenever a new file is created or uploaded. In some embodiments, the data store may be a cloud-based object store, such as Amazon S3, wherein the system relies on event notifications (e.g., S3 Event Notifications) to detect new object uploads. Such event-based monitoring ensures immediate awareness of file additions, thereby enabling timely processing of each new file.

Per the exemplary process 700, the system or process may parse the filename or extended attributes for date, provider, amount (704). For instance, upon detecting a new file, a system or process may analyze the file's metadata to extract purpose-specific core data. In one example, a simple parsing routine splits a filename at predetermined delimiters (e.g., underscores, hyphens) to retrieve a date, provider, and amount. For example, a file named “2025-01-05_ShopX_45.90.pdf” may be parsed by identifying the first segment (2025-01-05) as the date, the second segment (ShopX) as the provider, and the third segment (45.90) as the amount. In another embodiment, extended file attributes are used instead of filenames. Here, the system reads operating system-level attributes—e.g., xattr.date=“2025-01-05”, xattr.provider=“ShopX”, and xattr.amount=“45.90”. Each attribute value is then passed to subsequent routines without ever opening or rendering the file content.

Per the exemplary process 700, the system or process may re-name the file (if needed) to embed missing metadata or store metadata as extended attributes (706). For instance, after parsing, a system or process may determine whether any metadata field is missing or requires updating. For example, if the user-supplied date is incomplete or absent, the system may prompt the user to input the correct date or infer it from the file's creation timestamp. In one embodiment, the system automatically renames the file to embed the corrected or newly discovered metadata. By way of example, if a file named “ShopX.pdf” lacks date and amount data, the system could rename it to “2024-12-05_ShopX_45.90__generated.pdf.” The “__generated” suffix indicates that the value(s) in one or more fields are derived. A user or system may then easily identify which files should be reviewed and confirmed. In embodiments that rely on extended attributes, a custom attribute (e.g., “user.amount”) may be added or updated so that the file remains in compliance with a uniform metadata scheme. In still other embodiments, the system maintains a separate metadata record pointing to the file without changing its original name, preserving user-friendly naming conventions while embedding new or updated attribute data.

Per the exemplary process 700, the system or process may insert a new row, entry or record in a database or spreadsheet corresponding to the file (708). For instance, based on the established core data fields, a system or process may create or update a record representing the file in a chosen data structure, such as a relational database, NoSQL store, or spreadsheet. In one embodiment, a system or process opens a database connection and executes an “INSERT” statement with columns for date, provider, amount, and a unique file identifier or path. Alternatively, a spreadsheet-based implementation (e.g., Microsoft Excel, Google Sheets) receives the new row through a programmatic interface (e.g., a COM automation script for Excel, or a Google Sheets API call). Each record includes a reference to the file's physical or logical location (e.g., file path, URL, or object key), ensuring rapid retrieval and enabling downstream queries (such as expense calculations or tax reporting).

Per the exemplary process 700, the system or process may organize the files by automatically moving each into a subdirectory named after the provider (710). For instance, a system or process may enhance document organization by sorting the files based on parsed metadata. For example, if the “provider” field for a file is “ShopX,” the system checks for an existing “ShopX” directory within a predefined root folder (e.g., “/Invoices/2025/”). If the directory does not exist, the system creates it. The file is then moved—or, in some file systems, virtually linked—into that directory. In more advanced use cases, hierarchical structures may be created, for instance organizing by year and then by provider (/Invoices/2025/ShopX/). This approach simplifies future browsing, auditing, and retrieval, particularly in large repositories of invoices or receipts.

Per the exemplary process 700, the system or process may generate a hyperlink in the corresponding row, entry or record in the database or spreadsheet that opens the file for review (712). For instance, a system or process may create a clickable hyperlink in the newly inserted or updated record. In a database-backed web application, for instance, the hyperlink might be an HTTP or HTTPS link leading to a file server or cloud storage URL. In a spreadsheet environment, the system could insert a formula-based hyperlink (e.g., =HYPERLINK(“C:\Invoices\2025\ShopX\2025-01-05_ShopX_45.90.pdf”,“Open Receipt”)) in the relevant cell, allowing end-users to open the file immediately for review. This feature enables quick access to the original document content whenever a user needs to verify transaction details, confirm payment status, or review itemized charges. In one embodiment, a system or process may log or otherwise determine an absolute file path (e.g., “C: \Receipts\2024-01-01-Amazon-59.99.pdf”) or a unique file identifier (UUID) so that each record in the database or spreadsheet is directly correlated to the specific document independently of any parent folder or file path. One of ordinary skill in the art would appreciate that there are various synchronization or version control systems available for updating these location fields if files are moved or renamed.

It should be appreciated that the specific steps shown in FIGS. 4-7 are illustrative and should not be construed as limiting. For instance, certain implementations may omit or combine steps to better suit particular use cases. For example, the monitoring step 702 may rely solely on periodic polling rather than event-driven notifications to simplify integration with legacy systems. Similarly, parsing the filename or extended attributes (704) may be bypassed entirely in cases where the metadata is pre-supplied or extracted during earlier stages of document processing. For scenarios where files are already well-organized or standardized, the renaming step (706) may be omitted, and metadata updates can be confined to extended attributes or external metadata records. Furthermore, inserting rows into a database or spreadsheet (708) may be excluded if the primary goal is to organize files (710) without maintaining a structured data repository. Alternatively, for lightweight implementations, files may be moved into subdirectories (710) without creating hierarchical structures, relying instead on flat directories with unique identifiers in filenames to prevent conflicts. The hyperlink generation step (712) may also be omitted when file access is managed entirely through a dedicated database or cloud interface, eliminating the need for direct user interaction with file paths. In other variations, additional steps may be introduced, such as encrypting files before storage, tagging files with keywords for enhanced searchability, or integrating with third-party APIs to notify stakeholders of document updates. These and other modifications would be apparent to one skilled in the art and are encompassed within the spirit and scope of the present invention.

While the present invention has been described in connection with preferred aspects and specific embodiments, as illustrated in the various figures and detailed descriptions, it is understood that these implementations are illustrative and should not be construed as limiting. Other similar aspects, modifications, and additions may be made to the described embodiments to perform the same functions or achieve equivalent results without deviating from the spirit and scope of the present invention. Accordingly, the invention should be construed in breadth and scope in accordance with the appended claims.

For instance, variations may include incorporating additional metadata fields (e.g., payment status, currency code, invoice number), employing different organizational hierarchies (e.g., sorting by date, project codes, or other criteria instead of provider), or integrating with third-party services for notifications, data validation, or advanced analytics. The various procedures and methods described herein may be implemented using hardware, software, or a combination of both. Additionally, the invention may be embodied in non-transitory computer-readable storage media and/or computer-readable communication media. Examples of suitable storage media include magnetic disks or tapes, optical storage media such as compact discs (CDs) or digital versatile discs (DVDs), flash memory, hard drives, and any other machine-readable storage medium.

Furthermore, computer programs incorporating various features or aspects of the invention may be encoded on these media for storage and/or transmission. Such programs may take the form of program code (i.e., instructions) embodied in tangible media or in propagated signals, or any other machine-readable communications medium. The program code may be packaged with compatible devices or provided separately (e.g., via Internet download). When loaded into and executed by a machine, such as a computer or processor, the machine becomes an apparatus configured to practice the disclosed embodiments.

In addition to the specific implementations explicitly set forth herein, other aspects and implementations will be apparent to those skilled in the art upon consideration of the disclosed specification. It is intended that the specification and illustrated implementations be regarded as examples only, with the invention covering all modifications, equivalents, and variations within the scope of the appended claims.

What is claimed:

1. An electronic document, comprising:
content; and
metadata, wherein the metadata comprises date information, provider information, and amount information, and the content comprises information related to the date information, the provider information, and the amount information.

2. The computer-implemented entity of claim 1, wherein the metadata comprises a filename, and the filename comprises the date information, the provider information, and the amount information.

3. The computer-implemented entity of claim 2, wherein the filename comprises currency information.

4. The computer-implemented entity of claim 2, wherein the date information is in a date format, the amount information is in a decimal format, and the provider information comprises one or more spaces.

5. The computer-implemented entity of claim 2, wherein the filename comprises the date information, the provider information, the amount information, a separator or delimiter between the date information and the provider information, and another separator or delimiter between the provider information and the amount information.

6. The computer-implemented entity of claim 5, further comprising:
wherein the filename comprises the data information, the provider information, the amount information, and other information; and
wherein the filename comprises yet another separator or delimiter between the amount information and the other information.

7. The computer-implemented entity of claim 6, further comprising:
wherein the content comprises an electronic receipt or invoice, and the electronic receipt or invoice comprises the data information, the provider information, and the amount information; and
wherein the other information comprises item information, and the electronic receipt or invoice comprises the item information.

8. The computer-implemented entity of claim 1, wherein the metadata comprises extended file attributes, and the extend file attributes comprise the date information, the provider information, and the amount information.

9. A computer-implemented method, comprising:
reading, by a computer system, metadata, wherein a computer-readable entity comprises content and the metadata; and
retrieving, by the computer system, date information, provider information, and amount information from the metadata, wherein the content comprises information related to the date information, the provider information, and the amount information.

10. The computer-implemented method of claim 9, further comprising:
adding, by the computer system, a record to one or more databases, the record comprising the date information, the provider information, and the amount information;
reading, by the computer system, other metadata, wherein another computer-readable entity comprises other content and the other metadata;
retrieving, by the computer system, other date information, other provider information, and other amount information from the other metadata, wherein the other content comprises other information related to the other date information, the other provider information, and the other amount information;
adding, by the computer system, another record to the one or more databases, the other record comprising the other date information, the other provider information, and the other amount information; and
determining, by the computer system, a result based on at least in part the amount and the other amount.

11. The computer-implemented method of claim 10, further comprising:
wherein determining the result comprises determining, by the computer system, the result based on at least in part the amount, the other amount, the provider information, and the other provider information; and
storing the computer-readable entity and the other computer-readable entity in a common electronic folder or directory in relation to determining that the provider information matches the other provider information.

12. The computer-implemented method of claim 10, further comprising:
receiving, by the computer system, location information from a user;
obtaining, by the computer system, the computer-readable entity in relation to the location information; and
storing, by the computer system, the result to the one or more databases.

13. The computer-implemented entity of claim 12, further comprising:
determining, by the computer system, first location information, wherein the first location is associated with the computer-readable entity;
adding, by the computer system, the first location information to the record.

14. The computer-implemented method of claim 9, further comprising:
receiving, by the computer system, an indication of status in relation to the computer-readable entity; and
adding or updating, by the computer system, a status field in the metadata in relation to the indication of status.

15. The computer-implemented method of claim 9, wherein the metadata comprises a filename, and the filename comprises the date information, the provider information, and the amount information.

16. The computer-implemented method of claim 15, wherein the filename comprises at least one separator or delimiter, and the date information, the provider information, and the amount information do not comprise a separator or delimiter from among the at least one separator or delimiter.

17. The computer-implemented method of claim 15, further comprising:
wherein the filename comprises a delimited date field, a delimited provider field, a delimited amount field, and a delimited description field; and
wherein retrieving the date information, the provider information, and the amount information comprises reading the filename and extracting the date information from the delimited date field, the provider information from the delimited provider field, the amount information from the delimited amount field, and description information from the delimited description field.

18. The computer-implemented method of claim 9, further comprising:
wherein reading the metadata comprises reading, by the computer system, a plurality of metadata, wherein a plurality of computer-readable entities comprise the plurality of metadata;
wherein retrieving the date information, the provider information, and the amount information comprises retrieving, by the computer system, the date information, the provider information, and the amount information from each metadata from among the plurality of metadata; and
storing, by the computer system, the date information, the provider information, and the amount information into tabular form, wherein a column comprises the date information, another column comprises the provider information, and yet another column comprises the amount information.

19. The computer-implemented method of claim 18, further comprising:
creating or locating, by the computer system, a folder or directory matching the provider information, wherein a computer-readable entity from among the plurality of computer-readable entities comprises the provider information; and
storing, by the computer system, said computer-readable entity in said folder or directory.

20. A system, comprising:
one or more processors; and
one or more memories communicatively coupled to the one or more processors when the system is operational, the one or more memories bearing processor-executable instructions that, when executed by the one or more processors or on the system, cause the system at least to:
read metadata, wherein a computer-readable entity comprises content and the metadata; and
retrieve date information, provider information, and amount information from the metadata, wherein the content comprises information related to the date information, the provider information, and the amount information.
